(19) United States
(12) Patent Application Publication
(10) Pub. No.: US 2024/0055810 A1
(43) Pub. Date: Feb. 15, 2024

(54) PLUG, PLUG CONNECTOR SYSTEM, PLUG KIT, AND METHOD FOR THE FIELD TERMINATION OF A CABLE WITH A PLUG

(71) Applicant: Reichle & De-Massari AG, Wetzikon (CH)

(72) Inventors: Matthias Gerber, Rüti (CH); Bernhard Hofer, Effretikon (CH); Marco Zurkirchen, Bubikon (CH)

(21) Appl. No.: 18/259,240

(22) PCT Filed: Dec. 20, 2021
(86) PCT No.: PCT/EP2021/086721

§ 371 Date: Jun. 23, 2023

(30) Foreign Application Priority Data
Dec. 23, 2020 (DE) 102020134894.0

(51) Int. Cl. H01R 13/6593

(52) U.S. Cl. CPC H01R 13/6593; H01R 2201/04; H01R 13/7175

(57) ABSTRACT

A plug, in particular a single-pair ethernet plug, has a plug unit for plugging into a corresponding plug socket unit along a plug-in direction and has a wiring block for receiving two conductor cores of a cable, wherein the wiring block is in an assembled state connected to the plug unit along an assembly direction, which is perpendicular to the plug-in direction.

### PRIOR ART

The invention relates to a plug according to the preamble of claim 1, a plug connector system according to claim 13, a plug kit according to claim 14 and a method for the field termination of a cable with a plug according to claim 15.

Plugs with plug units for plugging into corresponding plug sockets and having wiring blocks to receive conductor cores are already known in the prior art. With the advent of single-pair ethernet connection techniques, which are supposed to provide in particular a suitable infrastructure for applications of the so-called Industrial Internet of Things (IIoT), new demands are also arising for the plugs which are to be used in such applications. First of all, plugs with particularly compact dimensions are required for many applications. What is more, novel applications increas-ingly require an installation on site. With the plugs known thus far, an installation of the wiring block is done along a plug-in direction or contrary to a plug-in direction, which is detrimental to the installation process.

The problem addressed by the invention is in particular to provide a plug of this kind having improved qualities in regard to the installation. The problem is solved according to the invention by the features of claims 1, 13, 14 and 15, while advantageous embodiments and modifications of the invention can be found in the de-pendent claims.

### Benefits of the Invention

The invention starts from a plug, in particular a single-pair ethernet plug, having a plug unit for plugging into a corresponding plug socket unit along a plug-in direction and having a wiring block for receiving two conductor cores of a cable.

It is proposed that the wiring block is in an assembled state connected to the plug unit along an assembly direction, which is perpendicular to the plug-in direction.

Thanks to such a configuration, a plug having improved qualities in terms of installation can be provided advantageously. In particular, an especially simple, fast and at the same time especially reliable wiring of the switch can be accomplished when the wiring block is connected to the plug unit perpendicular to the plug-in direction. Moreover, an especially compact plug can be provided advantageously, which can be used advantageously also in applications with limited space, such as server rooms having many plugs arranged close to each other.

Advantageously, the plug constitutes at least a part, in particular a subassembly, of a plug connector system. Preferably, the plug connector system moreover comprises at least one plug socket, which comprises the corresponding plug socket unit for plugging in the plug unit along the plug-in direction. The plug can comprise the cable. However, the cable can also be part of the plug connector system or be configured as an accessory part formed independently of the plug connector system.

The wiring block is provided for the wiring of the plug. In the assembled state, the wiring block connects the two conductor cores of the cable in an electrically conductive manner to the plug unit, in particular to corresponding plug contacts of the plug unit. The two conductor cores of the cable could be connected inseparably to the plug unit by means of the wiring block in the assembled state, for example, by soldering or crimping. Preferably, the two conductor cores of the cable are connected separably to the wiring block in the assembled state. For example, the two conductor cores of the cable could be separably connected to the plug unit in the assembled state by means of an Insulation Displacement Contact (IDC) connection, wherein the conductor cores are each pressed individually by means of the wiring block along with the insulation into a so-called cutting terminal in the plug unit so that the insulation is cut through and an electrically conducting connection of the conductor cores to the plug contact of the plug unit is produced. Alternatively, the two conductor cores of the cable could be separably connected to the plug unit by means of a so-called Insulation Piercing Contact (IPC), wherein the insulation piercing contact comprises at least one spike, which in the assembled state is pierced through the insulation of the conductor core, in particular by inserting the wiring block into the plug unit, such that an electrically conductive connection of the conductor cores to the plug contact of the plug unit is produced. Preferably, the plug-in direction runs parallel to a principal direction of extension of the plug unit. Preferably, the assembly direction runs perpendicular to the principal direction of extension of the plug unit. By a “principal direction of extension” of an object shall be meant a direction which runs parallel to the longest edge of the smallest geo-metrical cuboid that only just completely encloses the object.

In the present application, ordinal words such as “first” and “second”, placed before certain terms, serve merely for a distinguishing of objects and/or for a ranking among objects and do not imply any existing total number and/or ranking of the objects. In particular, a “second object” does not necessarily imply the presence of a “first object”.

By “provided” shall be meant in particular designed and/or configured. The fact that an object is provided for a particular function shall be understood to mean that the object fulfills and/or performs this particular function in at least one application and/or operating state.

It is further proposed that the plug unit has a receiving space for receiving the wiring block, which is open contrary to the assembly direction and contrary to the plug-in direction, in particular to the surroundings and in particular in a disassembled state. In this way, the installation can advantageously be further improved. Preferably, the plug contacts of the plug unit are arranged in the receiving space and oriented at least contrary to the assembly direction.

It is furthermore proposed that the wiring block is in the assembled state situated at least to a large extent inside the plug unit and in particular in the receiving space. Thanks to such a configuration, an especially compact plug can be provided advantageously. Such a compact plug is in particular advantageously suitable for applications with limited space, for example in server rooms having many plugs arranged close to each other. Preferably, the wiring block in the assembled state is situated at least to a large extent by 75% of its volume, in particular at least to a large extent by 80% of its volume, advantageously at least to a large extent by 85% of its volume, especially advantageously at least to a large extent by 90% of its volume, preferably at least to a large extent by 95% of its volume, inside the plug unit and in particular in the receiving space. Especially preferably, the wiring block in the assembled state is arranged entirely inside the plug unit.

Furthermore it is proposed that the plug comprises a plug shielding unit, which in the assembled state surrounds the plug unit at least section-wise, in particular with respect to the plug-in direction in the circumferential direction. In this way, a shielding of the plug can be advantageously achieved with simple technical means. In particular, a plug can be provided with advantageous qualities in terms of electromagnetic compatibility. Preferably, the plug shielding unit is designed to reduce, and preferably minimize, the transmission of electrical and/or electromagnetic, in particular high-frequency, interference signals from the surroundings to the conductor cores or from the conductor cores to the surroundings, in particular to nearby electrical and/or electronic devices in the vicinity.

Furthermore it is proposed that the plug shielding unit comprises a plug shielding element and a plug shielding flap which is pivotably connected to the plug shielding element and which is pivotable relative to the plug shielding element around a pivot axis running parallel to the plug-in direction. In this way, the installation can be advantageously improved. Preferably, the plug shielding flap is formed as a single piece with the plug shielding element. In this way, the number of transition sites in the plug shielding unit can advantageously be minimized, so that the relia-bility of the shielding can further be advantageously enhanced. Moreover, an especially low transfer impedance of the plug shielding unit can be achieved advantageously and thus a plug can be provided with improved qualities in terms of electromagnetic compatibility. By “single piece” is meant at least materially bonded, for example by a soldering process, and especially advantageously molded in a single piece.

The plug shielding element and the plug shielding flap could be firmly joined together, for example soldered, in an assembled state. In one advantageous embodiment, however, it is proposed that in the assembled state the plug shielding element and the plug shielding flap are snapped together with each other and/or with a plug housing of the plug unit. In this way, the installation can advantageously be further improved. Moreover, the plug shielding unit can be opened if necessary in an advantageously especially easy manner without the use of tools, for example, in order to replace a cable or the like. The plug shielding flap could have a snap element, which in the assembled state is snapped directly to a mating snap element on the plug shielding element. Preferably, the plug shielding element has a first snap element, which in the assembled state is snapped directly to a first mating snap element of the plug housing and the plug shielding flap advantageously has a second snap element, which in the assembled state is snapped directly to a second mating snap element of the plug housing, in particular in such a way that the plug shielding flap and the plug shielding element are indirectly snapped to each other.

Furthermore it is proposed that the plug shielding unit comprises two contacting tabs, which are provided for engaging around the cable and for crimping. In this way, a contacting of the plug shielding unit with the cable can be advantageously achieved with simple technical means. Preferably, the contacting tabs are provided for a contacting of the plug shielding unit with the cable. Preferably, the contacting tabs are furthermore provided for a strain relief of the cable. Thus, advantageously, a contacting of the cable with the plug shielding unit can be combined with a strain relief of the cable. Moreover, a strain relief of the cable can be advantageously achieved. However, alternatively or additionally, it would also be conceivable for the plug to have a strain relief, being configured as a component separate from the plug shielding unit.

Furthermore it is proposed that the plug comprises a cable kink protection, which is at least substantially closed in the circumferential direction with respect to the plug-in direction and which ensures a connection of the wiring block to the plug unit in the assembled state and in particular a connection of the plug shielding unit to the plug unit. Thanks to such a configuration, a plug having a multifunctional cable kink protection can be advantageously provided. The cable kink protection on the one hand advantageously protects the cable effectively against damage due to kinking and on the other hand it secures the connections of the plug unit to the wiring block and to the plug shielding unit. The cable kink protection is preferably configured separately from the plug unit and/or the plug shielding unit. The cable kink protection is provided in particular to receive at least the cable connected to the plug unit, in particular across the wiring block, and to protect it in particular against excessive strain, in particular a kinking, an excessive bending, and/or a tensile stress. Preferably, the cable kink protection has a cable protection section for this, which advantageously comprises at least one entrance opening for the cable and at least one exit opening for the cable, preferably oriented parallel to the entrance opening. Preferably, the cable kink protection is furthermore movable at least partly and/or at least for a portion in a direction deviating from the principal direction of extension of the plug unit. In particular, the cable kink protection estab-lishes a minimum bending radius for the cable.

Furthermore it is proposed that the cable kink protection comprises at least one connection element for connection to a coding element. Thanks to such a configuration, a coding of the plug can be achieved advantageously with simple technical means. At the same time, the functionality of the cable kink protection can advantageously be further enhanced. Preferably, the connection element is provided for a detachable connection to the coding element, in particular without the need for tools. In this way, the flexibility can be advantageously enhanced, in particular because different coding elements can be connected especially quickly, easily, and suitably to the cable kink protection. Preferably, the connection element is provided for a form-fitting and/or force-locking connection to the coding element, for example a clip connection and/or a plug-in connection and/or a latching connection and/or the like. The connection element can be configured to be part of an outer contour of the cable kink protection, for example a specially shaped region of a surface of the cable kink protection and/or a recess and/or an elevation and/or the like, without being limited to this. Preferably, the plug comprises the coding element. The coding element can be provided for a colored and/or a mechanical and/or an electrical or electronic coding, such as by means of RFID, without being limited to this.

In a further aspect of the invention, which can be considered in particular by itself or also in combination with further aspects of the invention, it is proposed that the plug comprises a plug shielding unit, which comprises a latch element for locking the plug unit with the plug socket unit and comprises an actuating element for unlocking the latch element, wherein the actuating element comprises an actuating tab and the latch element comprises a latching tab, which interact at least for an unlocking. If the plug comprises a plug shielding unit with a latch element, an especially compact plug can be provided advantageously. Furthermore, a manufac-turing process for the plug can be simplified advantageously when the latch element is part of the plug shielding unit. Preferably, the actuating tab and the latching tab contact each other in form-fitting and/or force-locking manner along a force impact area. Preferably, the latch element comprises a latch hook, which is connected to the latching tab and latches to a bolt receiver of a plug socket corresponding to the plug unit for the locking of the plug unit. During the unlocking, the actuating tab preferably transmits a torque along the force impact area to the latching tab, so that the latching tab and thus the latch hook is moved out from the bolt receiver in the plug socket and the plug is released for the unlocking.

Moreover, it is proposed that the actuating tab is oriented parallel to the plug-in direction and the latching tab is oriented antiparallel to the plug-in direction. In this way, a plug with an improved locking mechanism can be advantageously provided. In particular, advantageously, the dilemma existing with plugs known thus far between an adequate holding force of the plug inside a plug socket, on the one hand, and a simple unmounting of the plug from the plug socket, on the other hand, can advantageously be solved if the actuating tab is oriented parallel to the plug-in direction and the latching tab antiparallel to the plug-in direction. The actuating tab extends preferably from a point of the plug shielding unit situated close to a closed end of the plug, parallel to the plug-in direction. The latching tab extends preferably from a point of the plug shielding unit situated close to an open end of the plug, antiparallel, that is, contrary to the plug-in direction. By a “closed end” is meant a region of the plug adjoined by the cable in the assembled state of the plug. By an “open end” of the plug is meant a region of the plug, in particular the plug unit, which is intended to be inserted into the corresponding plug socket unit. In plugs known thus far from the prior art, latch elements are either applied from a closed end, so that the locking is spontaneously released under strong axial pulling on the plug contrary to the plug-in direction, which may be detrimental in many applications, or the latch elements are applied from an open end, in which case a large deflection of an actuating element is required in order to achieve an adequate deflection of the latch element for an unlocking. By having a two-part locking and an actuating tab which is applied from the closed side and a latching tab which is applied from the open side, both a reliable locking and a simple unlocking can be advantageously achieved.

Furthermore it is proposed that the plug unit has a latch receiving space for receiving the latch element at least during the unlocking. In this way, an especially compact plug can be advantageously provided. Moreover, a jamming of the latch element can be advantageously prevented, thus making possible an especially reliable unlocking. Preferably, the latch receiving space is situated in a direction perpendicular to the plug-in direction beneath the latch element.

The invention moreover relates to a plug connector system having at least one plug according to one of the previously described embodiments and having at least one plug socket, which comprises the corresponding plug socket unit. Such a plug connector system is distinguished, among other things, in particular by the aforementioned advantageous qualities of the plug, in particular in regard to an easy assembly and the compact dimensions of the plug. Furthermore, the plug connector system can comprise a plurality of further plugs, which are configured in particular identical to or different from the plug, and corresponding further plug sockets for them.

The invention moreover relates to a plug kit for the field termination of a plug according to one of the previously described embodiments, having the plug unit, the wiring block and the plug shielding unit. Such a plug kit is advantageously suited to an especially simple and fast field termination of a plug.

Furthermore, a method is proposed for the field termination of a cable with a plug, by means of the plug kit, wherein the cable is connected to the wiring block and the wiring block is then connected to the plug unit along the assembly direction, which is perpendicular to the plug-in direction. By means of such a method, an especially simple, fast and reliable assembly can be advantageously made possible.

The plug according to the invention and the method for field termination of a cable with a plug according to the invention should not be limited to the above described application and embodiment. In particular, the plug according to the invention and the method for field termination of a cable with a plug according to the invention in order to fulfill a functionality described herein can have a number of individual elements, components, and units, as well as steps of the method, different from the number mentioned herein.

### DRAWINGS

Further benefits will emerge from the following description of the figures. The drawings show eight exemplary embodiments of the invention. The drawings, the description, and the claims contain many features in combination. The person skilled in the art will advisedly consider the features even individually and combine them into further meaningful combinations.

There are shown:

FIG. 1 a plug connector system with a plug socket and a plug in a schematic perspective representation,

FIG. 2 the plug socket in a schematic representation,

FIG. 3 the plug socket with an optical fiber in a schematic representation,

FIG. 4 a plug socket kit for producing the plug socket,

FIG. 5 a schematic method flow chart of a method for producing the plug socket with the plug socket kit,

FIG. 6 a plug kit for the field termination of the plug,

FIG. 7 a cable kink protection of the plug and a coding element in two schematic views,

FIG. 8 a schematic method flow chart of a method for the field termination of a cable with the plug,

FIG. 9 a further exemplary embodiment of a plug in a schematic perspective representation,

FIG. 10 a plug kit for the field termination of the plug from the exemplary embodiment of FIG. 9,

FIG. 11 a schematic cross-sectional representation through a plug unit and a plug shielding unit of the plug from the exemplary embodiment of FIG. 9,

FIG. 12 a further exemplary embodiment of a plug with a plug unit and a plug shielding unit in a schematic cross-sectional representation,

FIG. 13 a further exemplary embodiment of a plug with a plug unit and a plug shielding unit in a schematic cross-sectional representation,

FIG. 14 a further exemplary embodiment of a plug with a plug unit and a plug shielding unit in a schematic cross-sectional representation,

FIG. 15 a further exemplary embodiment of a plug with a cable kink protection and a coding element in two schematic views,

FIG. 16 a further exemplary embodiment of a plug with a cable kink protection and a coding element in two schematic views and

FIG. 17 a further exemplary embodiment of a plug with a cable kink protection and a coding element in two schematic views.

### DESCRIPTION OF THE EXEMPLARY EMBODIMENTS

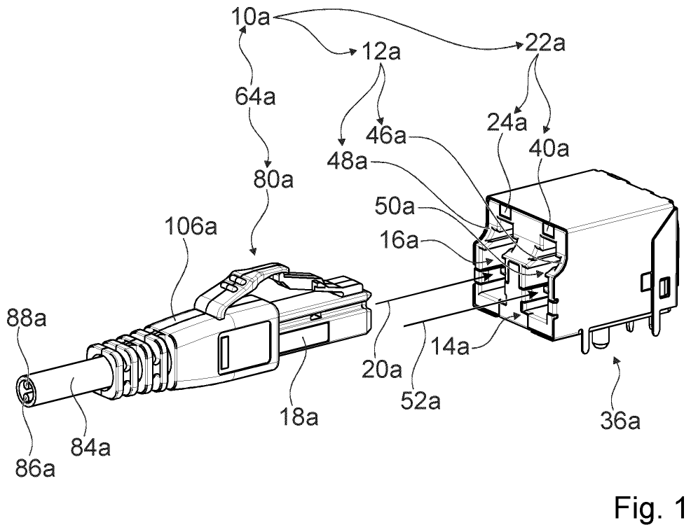

FIG. 1 shows a plug connector system 64a. The plug connector system 64a is designed as a single-pair ethernet plug connector system. The plug connector system 64a comprises a plug socket 10a and a plug 80a.

The plug socket 10a is designed as a single-pair ethernet plug socket. The plug socket 10a comprises a connection unit 36a for a connection to a circuit board (not shown). The plug socket 10a comprises a plug socket unit 12a. At a front side 14a, the plug socket unit 12a comprises a plug opening 16a. The plug opening 16a is provided to receive a corresponding plug unit 18a along a plug-in direction 20a. The plug socket unit 12a comprises a plug socket subunit 46a. The plug socket subunit 46a comprises the plug opening 16a. The plug socket unit 12a comprises a further plug socket subunit 48a. The further plug socket subunit 48a comprises a further plug opening 50a. The further plug opening 50a is provided to receive a further plug unit (not shown) along a further plug-in direction 52a. The further plug-in direction 52a is parallel to the plug-in direction 20a. The plug socket subunit 46a is made as a single piece with the further plug socket subunit 48a.

The plug 80a of the plug connector system 64a comprises the plug unit 18a corresponding to the plug opening 16a.

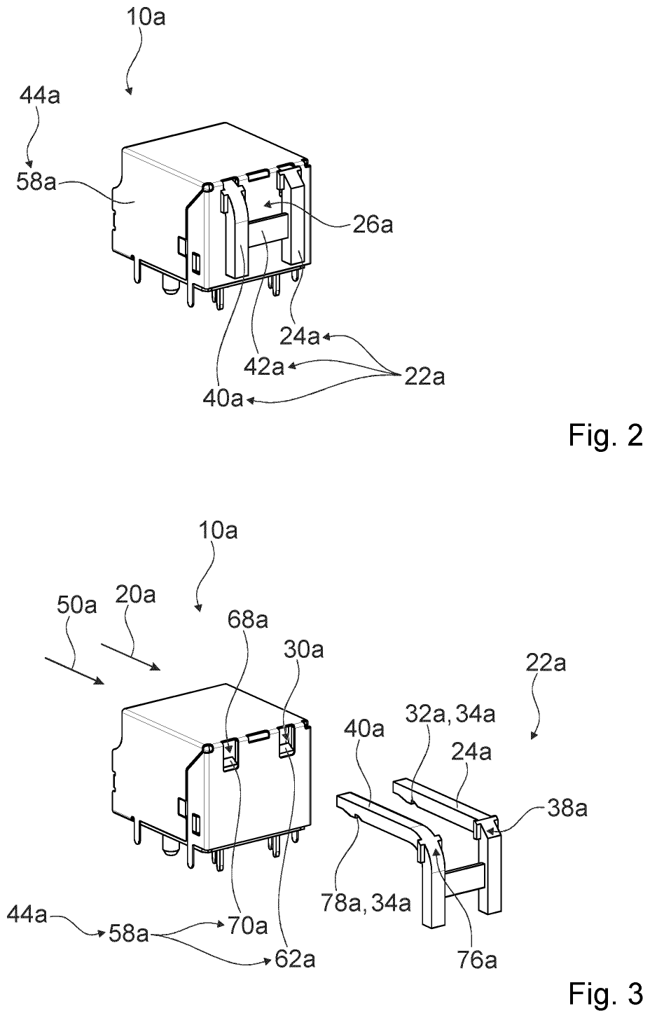

FIG. 2 shows the plug socket 10a in a schematic view. The plug socket 10a comprises a fiber optic unit 22a. The fiber optic unit 22a comprises at least one optical fiber 24a. The optical fiber 24a extends from a rear side 26a of the plug socket unit 12a to the front side 14a (see FIG. 1).

In the present instance, the fiber optic unit 22a comprises a further optical fiber 40a. The further optical fiber 40a extends likewise from the rear side 26a of the plug socket unit 12a to the front side 14a (see FIG. 1).

By means of the optical fiber 22a and/or the further optical fiber 40a of the fiber optic unit 22a, optical signals (not shown) can be transported in an operational state of the plug socket 10a from external signal sources (not shown), such as LEDs, which are mounted independently of the plug socket 10a on the circuit board, via the rear side 26a to the front side 14a, so that for example the operational state or a malfunction or the like can be indicated at the front side 14a of the plug socket 10a.

The fiber optic unit 22a comprises a connection web 42a. The connection web 42a connects the optical fiber 24a to the further optical fiber 40a. The connection web 42a is arranged between the optical fiber 24a and the further optical fiber 40a and is oriented basically perpendicular to the two optical fibers 24a, 40a.

FIG. 3 shows the plug socket 10a and the fiber optic unit 22a in a schematic representation. The plug socket unit 12a has at least one pass-through opening 30a to receive the optical fiber 24a. The pass-through opening 30a is situated at the plug socket subunit 46a of the plug socket unit 12a. The pass-through opening 30a extends from the rear side 26a to the front side 14a of the plug socket unit 12a and thus contrary to the plug-in direction 20a. In the present instance, the plug socket unit 12a has a further pass-through opening 68a to receive the further optical fiber 40a. The further pass-through opening 68a is situated at the further plug socket subunit 48a. The further pass-through opening 68a extends from the rear side 26a to the front side 14a and thus contrary to the further plug-in direction 52a.

The optical fiber 24a comprises a connection element 32a for a releasable connection to the plug socket unit 12a. In the present instance, the connection element 32a is configured as a catch element 34a and is provided for a latching to a mating locking element (not shown) of the plug socket unit 12a, situated in and/or at the pass-through opening 30a. The connection element 32a of the optical fiber 24a which is configured as the catch element 34a is configured in the present instance as a latching recess. The mating locking element situated inside the pass-through opening 30a is configured as a latching hook corresponding to the catch element 34a.

The further optical fiber 40a comprises a further connection element 78a. The further connection element 78a is configured as a catch element 34a, namely, as a latching recess, and it is designed to latch to a further mating locking element (not shown) situated in and/or at the further pass-through opening 68a. The further connection element 78a of the further optical fiber 40a is basically identical in configuration to the connection element 32a of the optical fiber 24a.

The optical fiber 24a has a deflection region 38a for the deflection of an optical signal (not represented). The deflection region 38a is configured as an angular surface inside the optical fiber 24a. The optical signal is deflected in the deflection region 38a by means of total reflection, similar to a periscope.

The further optical fiber 40a has a further deflection region 76a. By contrast with the deflection region 38a of the optical fiber 24a, the further deflection region 76a of the further optical fiber 40a has a radius and is curved, similar to a glass fiber.

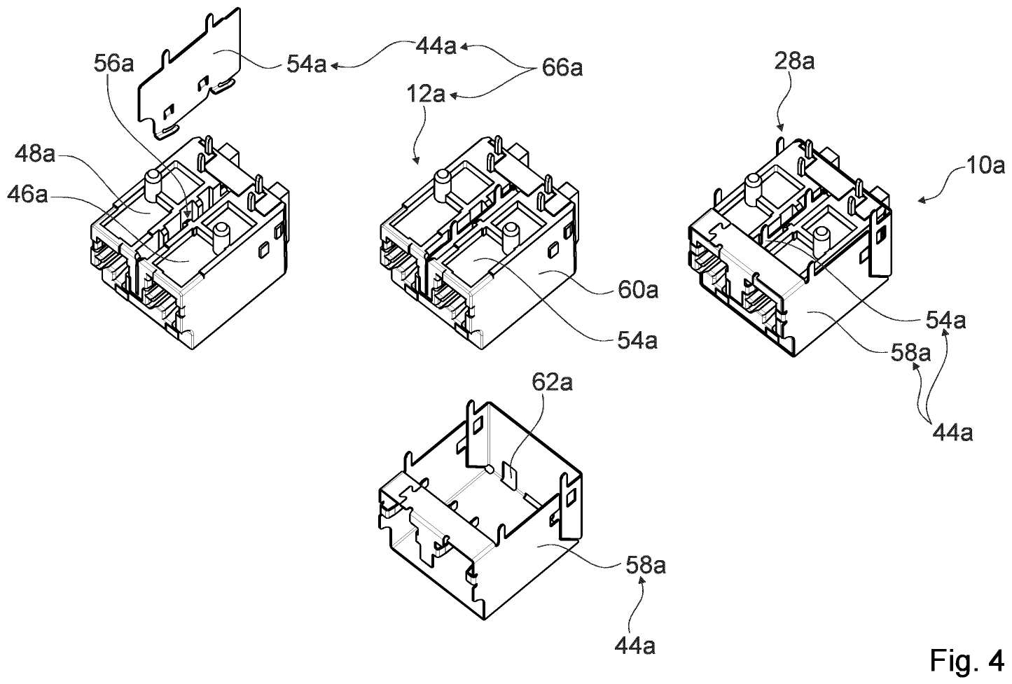

FIG. 4 shows a plug socket kit 66a for producing the plug socket 10a in various schematic views. The plug socket kit 66a encompasses the plug socket unit 12a, the fiber optic unit 22a (see FIG. 3) and a plug socket shielding unit 44a. In a representation of FIG. 4 at the right side, the plug socket 10a is shown in an assembled state in a schematic view of an underside 28a of the plug socket unit 12a. The plug socket 10a comprises the plug socket shielding unit 44a. The plug socket shielding unit 44a comprises an inner shielding element 54a and an outer shielding element 58a. The inner shielding element 54a is arranged in the assembled state between the plug socket subunit 46a and the further plug socket subunit 48a. In a lefthand view of FIG. 4, the plug unit 12a and the inner shielding element 54a are shown schematically. The plug socket unit 12a has a shielding opening 56a. The shielding opening 56a is provided to receive the inner shielding element 54a of the plug socket shielding unit 44a. The shielding opening 56a is arranged between the plug socket subunit 46a and the further plug socket subunit 48a. A middle view of FIG. 4 shows the plug unit 12a with the inner shielding element 54a arranged in the shielding opening 56a. The outer shielding element 58a in the assembled state covers at least the major portion of an outer side 60a of the plug socket unit 12a.

The outer shielding element 58a has at least one recess 62a for leading through the optical fiber 24a. In the present instance, the outer shielding element 58a has a further recess 70a (see FIG. 3) to lead through the further optical fiber 40a. The recess 62a is situated in front of the pass-through opening 30a. The further recess 70a is situated in front of the further pass-through opening 68a (see FIG. 3).

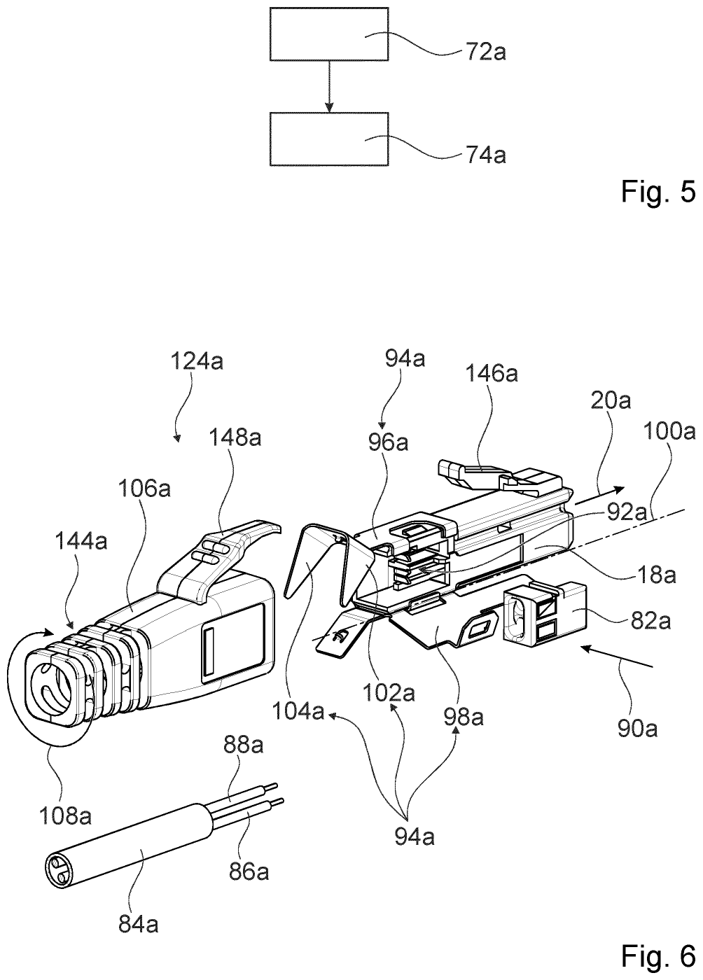

FIG. 5 shows a schematic flow chart of a method for producing the plug socket 10a with the plug socket kit 66a. The method involves at least two steps of the method 72a, 74a. In a first step of the method 72a, the plug socket unit 12a is provided with the plug socket shielding unit 44a. First of all, the inner shielding element 54a is introduced into the shielding opening 56a of the plug socket unit 12a (see FIG. 4). Next, in the first step of the method 72a, the outer shielding element 58a is placed on the outer side 60a of the plug unit 12a and contacted with the inner shielding element 54a (see FIG. 4). In a second step of the method 74a, the fiber optic unit 22a is connected to the plug unit 12a. The optical fiber 24a in this process is led in through the recess 62a of the outer shielding element 58a into the pass-through opening 30a of the plug socket unit 12a from the rear side 26a and contrary to the plug-in direction 20a (see FIG. 3). At the same time, in the further step of the method 72a, the further optical fiber 40a, which is connected to the optical fiber 24a by the connection web 42a, is led in through the further recess 70a of the outer shielding element 58a into the further pass-through opening 68a of the plug socket unit 12a, contrary to the further plug-in direction 52a (see FIG. 3). Upon introducing the optical fiber 24a into the pass-through opening 30a of the plug socket unit, the connection element 32a fashioned as the catch element 34a is latched to the mating locking element. Likewise, upon introducing the further optical fiber 40a into the further pass-through opening 68a, the further connection element 78a fashioned as the catch element 34a is latched to the further mating locking element (see FIG. 3).

The plug 80a of the plug connector system 64a represented in FIG. 1 comprises the plug unit 18a for plugging into the corresponding plug socket unit 12a of the plug socket 10a.

The plug 80a comprises a wiring block 82a (see FIG. 6) for receiving two conductor cores 86a, 88a of a cable 84a. In an assembled state of the plug 80a, as represented in FIG. 1, the wiring block 82a is connected to the plug unit 18a along an assembly direction 90a, which is perpendicular to the plug-in direction 20a. The wiring block 82a in the assembled state is arranged at least to a large extent inside the plug unit 18a. In the present instance, the wiring block 82a is situated entirely in the plug unit 18a.

The plug 80a comprises a plug shielding unit 94a (see FIG. 6). In the assembled state, the plug shielding unit 94a surrounds the plug unit 18a at least for a portion.

FIG. 6 shows a plug kit 124a for the field termination of the plug 80a. In FIG. 6, the plug 82a is represented in a disassembled state. The plug kit 122a encompasses the plug unit 18a, the wiring block 82a and a plug shielding unit 94a of the plug 80a (see FIG. 1).

The plug unit 18a comprises a locking element 146a. The locking element 146a is provided for a locking of the plug unit 18a in the plug opening 16a of the plug socket 10a (see FIG. 1).

The plug unit 18a has a receiving space 92a to receive the wiring block 82a. The receiving space 92a is open toward the assembly direction 90a and toward the plug-in direction 20a, in particular to the surroundings and in particular in the disassembled state of the plug 80a, as represented in FIG. 6.

The plug shielding unit 94a comprises a plug shielding element 96a and a plug shielding flap 98a. The plug shielding flap 98a is pivotably connected to the plug shielding element 96a. The plug shielding flap 98a can pivot relative to the plug shielding element 96a about a pivot axis 100a. The pivot axis 100a runs parallel to the plug-in direction 20a.

The plug shielding unit 94a comprises two contacting tabs 102a, 104a. The contacting tabs 102a, 104a are provided for reaching around and crimping the cable. In the assembled state of the plug 80a, the contacting tabs 102a, 104a reach around the cable 84a and are crimped with it, so that the plug shielding unit 94a makes contact with the cable 84a. Furthermore, the contacting tabs 102a, 104a in the assembled state serve for a strain relief of the cable 84a.

The plug 80a comprises a cable kink protection 106a to protect the cable 84a against kinking. The cable kink protection 106a is at least substantially closed in a circumferential direction 108a with respect to the plug-in direction 20a. In the assembled state of the plug 80a, the cable kink protection 106a secures the connection of the wiring block 82a to the plug unit 18a as well as a connection of the plug shielding unit 94a to the plug unit 18a.

The cable kink protection 106a has a flexible region 144a. In the assembled state, the flexible region 144a surrounds the cable 84a, so that it can move flexibly.

The cable kink protection 106a comprises an unlocking element 148a. The unlocking element 148a is provided for unlocking the locking element 146a in a locked state of the plug unit 18a in the plug opening 16a of the plug socket 10a (see FIG. 1).

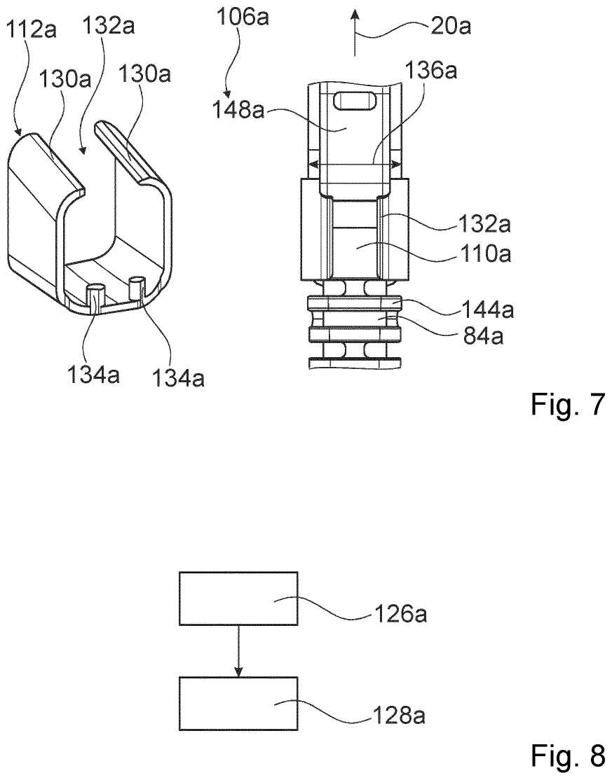

The cable kink protection 106a comprises a connection element 110a. The connection element 110a is provided for a connection to a coding element 112a (see FIG. 7). The connection element 110a is formed as a specially shaped outer contour of the cable kink protection 106a between the actuating element 148a and the flexible region 144a.

FIG. 7 shows the coding element 112a once in a schematic single view and once in connection with the cable kink protection 106a. The coding element 112a comprises two grab hooks 130a arranged opposite each other and in mirror sym-metry, which are separated from each other by an opening 132a. The grab hooks 130a are elastically deformable. The coding element 112a comprises two pins 134a, which engage with appropriately shaped recesses (not shown) of the connection element 110a when connected to the cable kink protection 106a.

For a connection of the coding element 112a to the cable kink protection 106a, the two grab hooks 130a are pulled apart in opposite directions, so that the opening 132a widens to a width 136a of the cable kink protection 106a. After this, the coding element 112a is pushed onto the cable kink protection 106a from an underside. The grab hooks 130a thanks to their elasticity return to their starting position and reach around the connection element 110a of the cable kink protection 106a with form fit. In addition, the pins 134a of the coding element 112a engage with the recesses of the connection element 110a, so that a slipping of the coding element 112a in the direction of the flexible region of the cable kink protection 106a is prevented.

FIG. 8 shows a schematic flow chart of a method for the field termination of the cable 84a with the plug 80a by means of the plug kit 124a. The method involves at least two steps of the method 126a, 128a. In one step of the method 126a, the cable 84a is connected to the wiring block 82a. The two conductor cores 86a, 88a of the cable 84a are led into the wiring block 82a and an excess of the conductor cores 86a, 88a is cut off. Next, in a further step of the method 128a, the wiring block 82a is connected to the plug unit 18a along the assembly direction 90a. The wiring block 82a is inserted into the receiving space 92a, so that the conductor cores 86a, 88a of the cable 84a are connected to the plug contacts of the plug unit 18a by means of a separable insulation displacement connection.

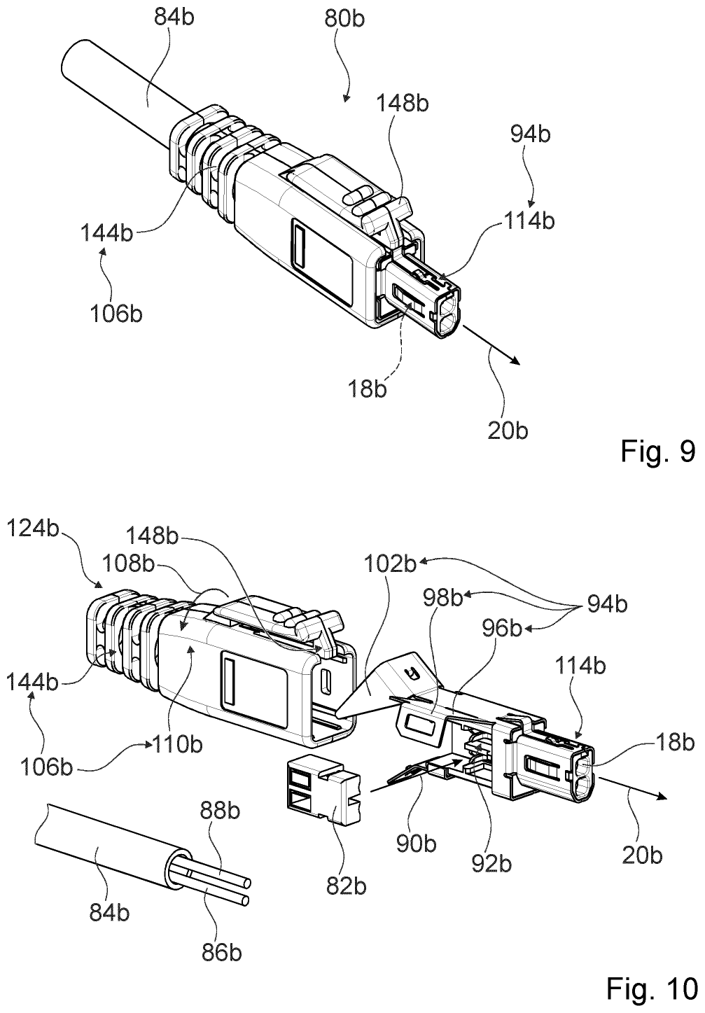

In FIGS. 9 to 17, seven further exemplary embodiments of the invention are shown. The following descriptions and the drawings are limited basically to the differences between the exemplary embodiments, while regarding identically des-ignated components, in particular in regard to components with the same reference numbers, one may refer basically to the drawings and/or the description of the other exemplary embodiments, in particular FIGS. 1 to 8. In order to distin-guish the exemplary embodiments, the letter a is placed after the reference numbers of the exemplary embodiment in FIGS. 1 to 8. In the exemplary embodiments of FIGS. 9 to 17, the letter a is replaced by the letters b through h.

FIG. 9 shows a further exemplary embodiment of a plug 80b in a schematic view. The plug 80b differs from the plug 80a of the preceding exemplary embodiment in particular in regard to a connection type. The plug 80b is designed as a MSP plug. The plug 80b comprises a plug unit 18b for plugging into a corresponding plug socket (not shown) along a plug-in direction 20b.

The plug 80b comprises a wiring block 82b (see FIG. 10) for receiving two conductor cores 86b, 88b of a cable 84b. In an assembled state of the plug 80b, the wiring block 84b is connected to the plug unit 18b along an assembly direction 90b, which is perpendicular to the plug-in direction 20b. The wiring of the plug 80b by means of the wiring block 82b is done basically identical to the wiring of the plug 80a by means of the wiring block 82a, so that in this regard reference is made to the above description of the exemplary embodiment of FIGS. 1 to 6.

The plug 80b comprises a plug shielding unit 94b. In the assembled state of the plug 80b, the plug shielding unit 94b surrounds the plug unit 18b at least for a portion.

The plug shielding unit 94b comprises a latch element 114b for the locking of the plug unit 18b to a plug socket unit (not shown) and an actuating element 116b. The latch element 114b comprises a latching tab 120b. The actuating element 116b comprises an actuating tab 118b. The actuating element 116b and the latch element 120b interact at least for an unlocking.

FIG. 10 shows a plug kit 124b for the field termination of the plug 80b in a schematic view. A field termination of the plug 80b by means of the plug kit 122b is done basically similar to the previously described field termination of the plug 80a by means of the plug kit 122a of the previous exemplary embodiment.

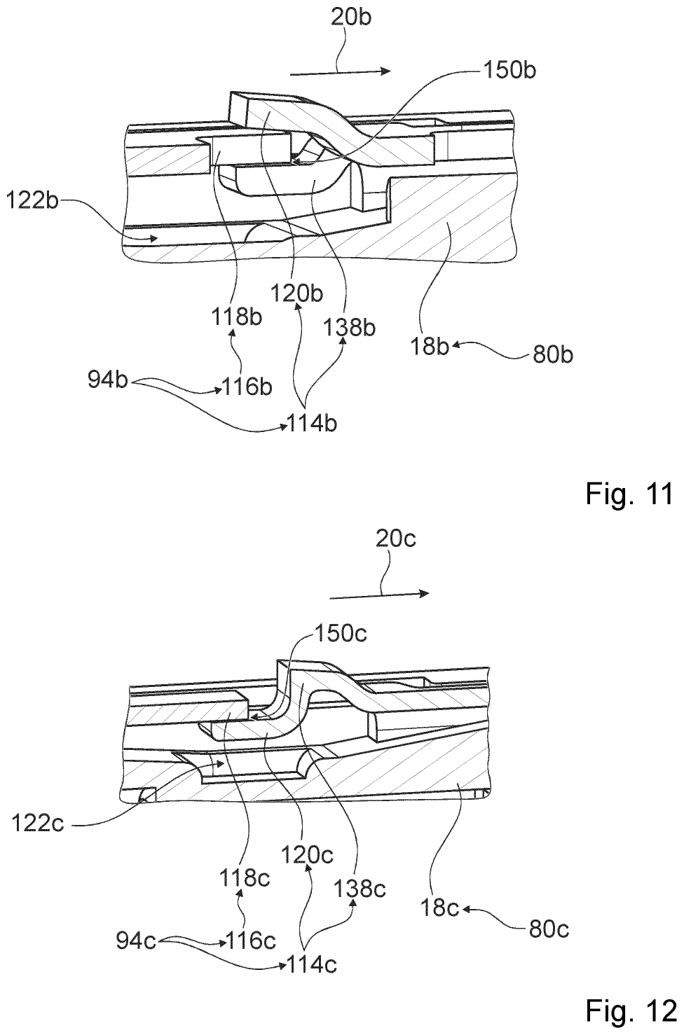

FIG. 11 shows the plug unit 18b and the plug shielding unit 94b of the plug 80b in a schematic cross-sectional representation. The actuating tab 118b is oriented parallel to the plug-in direction 20b. The latching tab 120b is oriented antiparallel to the plug-in direction 20b. The actuating tab 118b contacts the latching tab 120b in form-fit and/or force-locking along a force impact area 150b. The latch element 114b comprises a latch hook 138b. In a locked state of the plug unit 18b with a corresponding plug socket (not shown), the latch hook 138b is locked to the plug socket. The latch hook 138b is connected to the latching tab 120b and arranged with an offset to the side relative to the latching tab 120b in the plug-in direction 20b.

The plug unit 18b has a latch receiving space 122b for receiving the latch element 114b at least during the unlocking.

The plug 80b comprises a cable kink protection 106b to protect a cable 84b (see FIG. 10). The cable kink protection 106b comprises an unlocking element 148b. For the unlocking, the actuating tab 120b is activated by pressing on the unlocking element 148b. A torque is then exerted by the actuating tab 120b on the latching tab 120b and the latching tab 120b is moved in the direction of the latch receiving space 122b. In this process, the latch hook 138b likewise moves in the direction of the latch receiving space 122b and the plug unit 18b is unlocked and can be pulled out from the plug socket contrary to the plug-in direction 20b.

FIG. 12 shows a further exemplary embodiment of a plug 80c in a schematic cross-sectional representation through a plug unit 18c and a plug shielding unit 94c of the plug 80c. The plug 80c differs from the plug 80b of the preceding exemplary embodiment basically in regard to a latch element 114c of a plug shielding unit 94c. Otherwise, one can refer to the above descriptions of the plug 80a and 80b. The latch element 114c comprises an actuating tab 118c and a latching tab 120c. The actuating tab 118c and the latching tab 120c interact at least for an unlocking. The latch element 114c comprises a latch hook 138c. By contrast with the preceding exemplary embodiment, the latch hook 138c is not offset to the side relative to the latching tab 120c in a plug-in direction 20c, but instead extends over the entire width of the latch element 114c perpendicular to the plug-in direction 20c. The actuating tab 118c and the latching tab 120c likewise extend over the entire width of the latch element 114c perpendicular to the plug-in direction 20c, so that a force impact area 150c along which the actuating tab 118c contacts the latching tab 120c in form-fit and/or force-locking manner is greater than the force impact area 150b of the preceding exemplary embodiment. Thus, a more efficient force transmission from the actuating tab 118c to the latching tab 120c can be achieved.

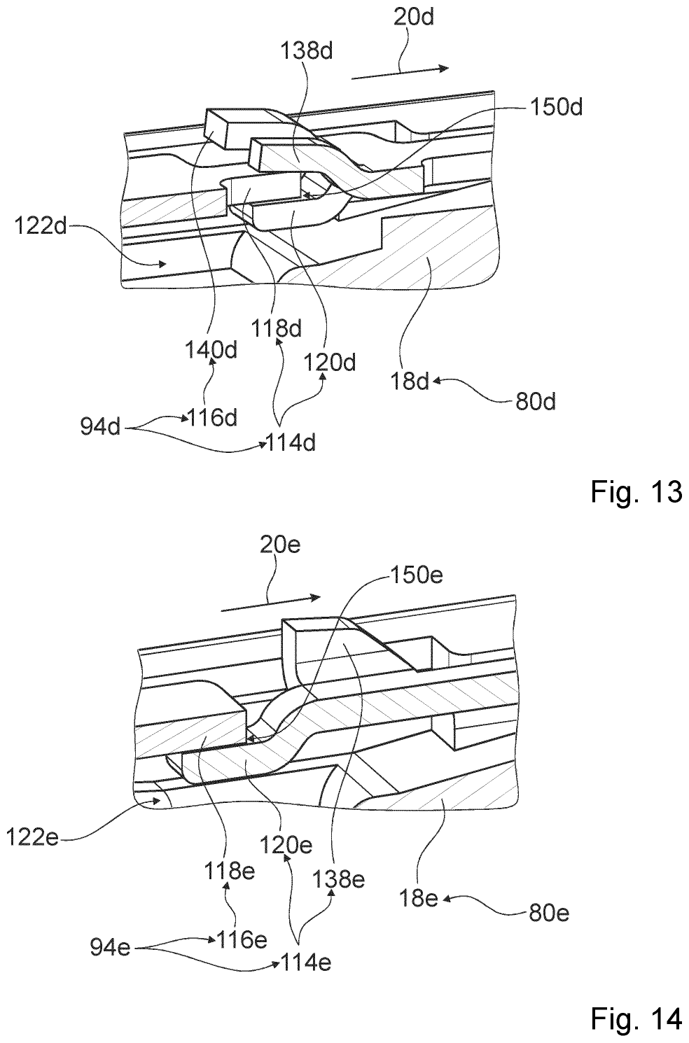

FIG. 13 shows a further exemplary embodiment of a plug 80d in a schematic cross-sectional representation through a plug unit 18d and a plug shielding unit 94d of the plug 80d. The plug 80d differs from the plugs 80b and 80c of the preceding exemplary embodiments basically in regard to a latch element 114d of a plug shielding unit 94d. Otherwise, one can refer to the above descriptions of the plugs 80a and 80b. The latch element 114d comprises an actuating tab 118d and a latching tab 120d, which interact at least for an unlocking. The latch element 114d comprises a latch hook 138d and a further latch hook 140d. Looking along a plug-in direction 20d, the latch hook 138d and the further latch hook 140d are arranged with an offset relative to each other. The latching tab 120d is arranged with the latch hook 138d and the further latch hook 140d and extends beneath the latch hook 138d and the further latch hook 140d across a gap, the width of which corre-sponds to the spacing between the latch hook 138d and the further latch hook 140d. By contrast with the previous exemplary embodiments of FIGS. 11 and 12, a more uniform force transmission is possible by means of the latch element 114d during the unlocking and thus a more reliable unlocking is achieved.

FIG. 14 shows a further exemplary embodiment of a plug 80e in a schematic cross-sectional representation through a plug unit 18e and a plug shielding unit 94e of the plug 80e. The plug 80e differs from the plugs 80b to 80d of the preceding exemplary embodiments basically in regard to a latch element 114e of the plug shielding unit 94e. Otherwise, one can refer to the above descriptions of the plug 80a and 80b. The latch element 114e comprises an actuating tab 118e and a latching tab 120e, which interact at least for an unlocking. The latch element 114e comprises a latch hook 138e. By contrast with the exemplary embodiments of FIGS. 11 to 13, the latch hook 138e is oriented perpendicular to the latching tab 120e. The latching tab 120e and the actuating tab 118e extend across the entire width of the latch element 114e, so that a force impact area 150e is enlarged, similar to the exemplary embodiment of FIG. 12, and a force transmission from the actuating tab 118e to the latching tab 120e is especially efficient.

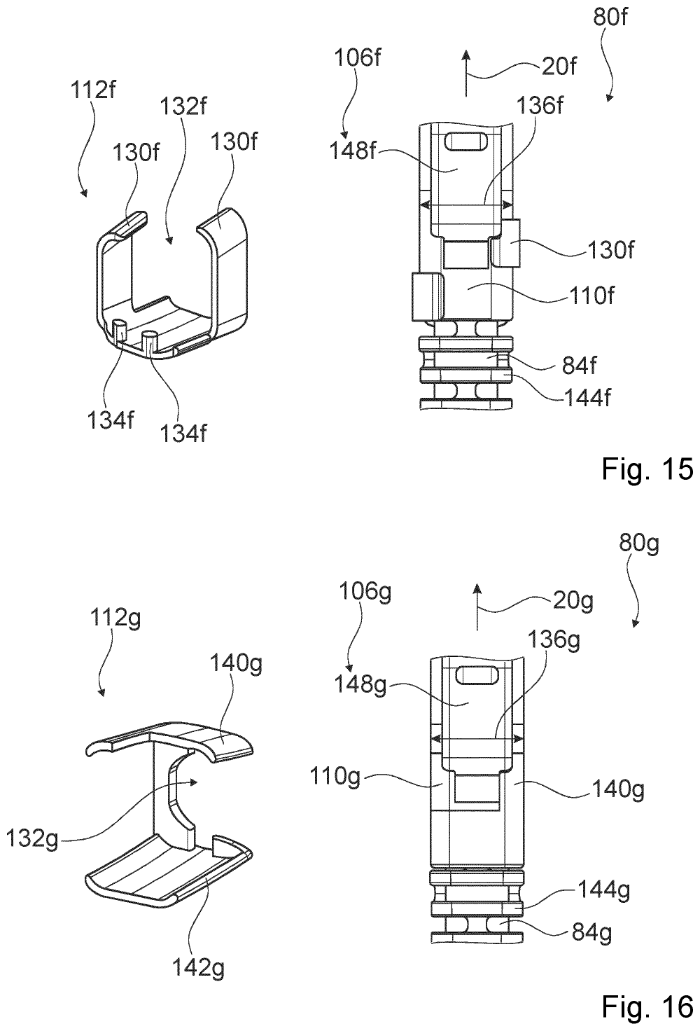

FIG. 15 shows a further exemplary embodiment of a plug 80f. The plug 80f differs from the preceding exemplary embodiments solely in regard to the configuration of a coding element 112f for connection to a cable kink protection 106f of the plug 80f. The plug 80f can otherwise be configured basically according to one of the configurations described above for the plugs 80a to 80e. By contrast with the coding element 112a of the plug 80a shown in FIG. 7, the coding element 112f has two slender grab hooks 130f, which are arranged with an offset from each other along a plug-in direction 20f in a connected state to the cable kink protection 106f. In this way, a space saving can be advantageously achieved in arrangements with multiple plugs 80f arranged alongside each other and perpendicular to the plug-in direction 20f. Since the grab hooks 130f of the coding element 112f are offset from each other in the plug-in direction 20f, multiple plugs 80f can be placed more closely together, each time separated by a wall thickness of a grab hook 130f, as compared to an arrangement with multiple plugs 80f each having one coding element 112f.

FIG. 16 shows a further exemplary embodiment of a plug 80g. The plug 80g differs from the preceding exemplary embodiments solely in regard to the configuration of a coding element 112g for connection to a cable kink protection 106g of the plug 80g. The plug 80g can otherwise be configured basically according to one of the configurations described above for the plugs 80a to 80e. By contrast with the coding elements 112a and 112f shown in FIGS. 7 and 15, the coding element 112g of the plug 80g is formed without pins. Furthermore, the coding element 112g is connected to a connection element 110g of the cable kink protection 106g not from an underside, but instead laterally. The coding element 112g comprises an upper grab hook 140g and a lower grab hook 142g, which are arranged opposite each other in regard to an opening 132g of the coding element 112g. In a connected state of the coding element 112g, the width 136g of the cable kink protection 106g is exceeded neither by the upper grab hook 140g nor by the lower grab hook 142g. Thus, a space saving can advantageously be further increased in arrangements with multiple plugs 80g alongside each other as compared to the coding element 112f of the previous exemplary embodiment.

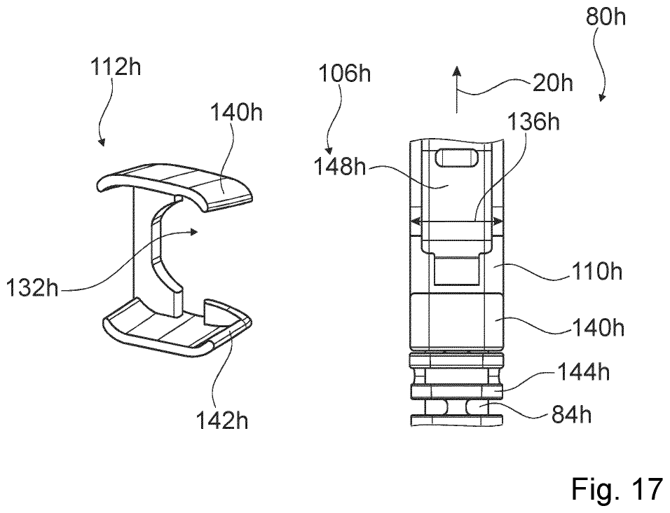

FIG. 17 shows a further exemplary embodiment of a plug 80h. The plug 80h differs from the preceding exemplary embodiments solely in regard to the configuration of a coding element 112h for connection to a cable kink protection 106h of the plug 80h. The plug 80h can otherwise be configured basically according to one of the configurations described above for the plugs 80a to 80e. By contrast with the coding element 112g of the preceding exemplary embodiment, an upper grab hook 140h and a lower grab hook 142h of the coding element 112h each have a lesser extension in the longitudinal direction. Thus, the coding element 112h in a state connected to the cable kink protection 106h has overall a lesser extension in the longitudinal direction parallel to a plug-in direction 20h of the plug 80h. Accord-ingly, a connection element 110h of the cable kink protection 106h for connection to the coding element 112h is also shorter in the longitudinal direction parallel to the plug-in direction 20h of the plug 80h as compared to the preceding exemplary embodiments, so that advantageously a space saving can be achieved in the plug-in direction 20h.

### REFERENCE NUMBERS

10 Plug socket
12 Plug socket unit
14 Front side
16 Plug opening
18 Plug unit
20 Plug-in direction
22 Fiber optic unit
24 Optical fiber
26 Rear side
28 Underside
30 Pass-through opening
32 Connection element
34 Catch element
36 Connection unit
38 Deflection region
40 Further optical fiber
42 Connection web
44 Plug socket shielding unit
46 Plug socket subunit
48 Further plug socket subunit
50 Further plug opening
52 Further plug-in direction
54 Inner shielding element
56 Shielding opening
58 Outer shielding element
60 Outer side
62 Recess
64 Plug connector system
66 Plug socket kit
68 Further pass-through opening
70 Further recess
72 First step of the method
74 Second step of the method
76 Further deflection region
78 Further connection element
80 Plug
82 Wiring block
84 Cable
86 Conductor core
88 Further conductor core
90 Assembly direction
92 Receiving space
94 Plug shielding unit
96 Plug shielding element
98 Plug shielding flap
100 Pivot axis
102 Contacting tab
104 Further contacting tab
106 Cable kink protection
108 Circumferential direction
110 Connection element
112 Coding element
114 Latch element
116 Actuating element
118 Actuating tab
120 Latching tab
122 Latch receiving space
124 Plug kit
126 Step of the method
128 Further step of the method
130 Grab hook
132 Opening
134 Pin
136 Width
138 Latch hook
140 Further latch hook
142 Lower grab hook
144 Flexible region
146 Locking element
148 Unlocking element
150 Force impact area

1. A plug, in particular a single-pair ethernet plug, having a plug unit for plugging into a corresponding plug socket unit along a plug-in direction and having a wiring block for receiving two conductor cores of a cable, wherein the wiring block is in an assembled state connected to the plug unit along an assembly direction, which is perpendicular to the plug-in direction.

2. The plug has claimed in claim 1, wherein the plug unit has a receiving space for receiving the wiring block, which is open contrary to the assembly direction and contrary to the plug-in direction.

3. The plug as claimed in claim 1, wherein the wiring block is in the assembled state situated at least to a large extent inside the plug unit.

4. The plug as claimed in claim 1, comprising a plug shielding unit, which in the assembled state surrounds the plug unit at least section-wise.

5. The plug as claimed in claim 4, wherein the plug shielding unit comprises a plug shielding element and a plug shielding flap which is pivotably connected to the plug shielding element and which is pivotable relative to the plug shielding element around a pivot axis running parallel to the plug-in direction.

6. The plug as claimed in claim 5, wherein in the assembled state the plug shielding element and the plug shielding flap are snapped together with each other and/or with a plug housing of the plug unit.

7. The plug as claimed in claim 4, wherein the plug shielding unit comprises two contacting tabs, which are provided for engaging around the cable and for crimping.

8. The plug at least as claimed in claim 4, comprising a cable kink protection, which is at least substantially closed in a circumferential direction with respect to the plug-in direction and which ensures a connection of the wiring block to the plug unit and in particular a connection of the plug shielding unit to the plug unit.

9. The plug as claimed in claim 8, wherein the cable kink protection comprises at least one connection element for a connection to a coding element.

10. The plug as claimed in claim 1, comprising a plug shielding unit, which comprises a latch element for locking the plug unit with the plug socket unit and comprises an actuating element for unlocking the latch element, wherein the actuating element comprises an actuating tab and the latch element comprises a latching tab, which interact at least for an unlocking.

11. The plug as claimed in claim 10, wherein the actuating tab is oriented parallel to the plug-in direction and the latching tab is oriented antiparallel to the plug-in direction.

12. The plug as claimed in claim 10, wherein the plug unit has a latch receiving space for receiving the latch element at least during the unlocking.

13. A plug connector system, having at least one plug as claimed in claim 1 and having at least one plug socket, which comprises the corresponding plug socket unit.

14. A plug kit for the field termination of a plug as claimed in claim 10, having the plug unit, the wiring block and the plug shielding unit.

15. A method for field termination of a cable with a plug by means of a plug kit as claimed in claim 14, wherein the cable is connected to the wiring block and the wiring block is then connected to the plug unit along the assembly direction, which is perpendicular to the plug-in direction.

16. A plug, in particular a single-pair ethernet plug, having a plug unit for plugging into a corresponding plug socket unit along a plug-in direction and having a wiring block for recovering two conductor cores of a cable, comprising a plug shielding unit, which comprises a latch element for locking the plug unit with the plug socket unit and comprises an element for unlocking the latch element, wherein the actuating element comprises an actuating tab and the latch element comprises a latching tab, which interact at least for an unlocking.
